(19) United States
(12) Patent Application Publication
(10) Pub. No.: US 2010/0227976 A1
(43) Pub. Date: Sep. 9, 2010

(54) THERMOPLASTIC ELASTOMER COMPOSITION, AND VIBRATION-PROOF SOUND-PROOF MEMBER COMPRISING THE COMPOSITION

(76) Inventors: Hiroaki Nakano, Hyogo (JP); Hideyuki Okuyama, Hyogo (JP)

Correspondence Address: BIRCH STEWART KOLASCH & BIRCH, PO BOX 747, FALLS CHURCH, VA, 22040-0747, US

(21) Appl. No.: 12/682,167

(22) PCT Filed: Oct. 9, 2008
(86) PCT No.: PCT/JP2008/068353

§ 371 Date: Apr. 8, 2010

(30) Foreign Application Priority Data
Oct. 15, 2007 (JP) 2007-267539

(51) Int. Cl. C08L 9/00

(52) U.S. Cl. 525/232

(57) ABSTRACT

Disclosed is a thermoplastic elastomer composition which is excellent in a vibration-proof property and a sound-proof property, and which has flexibility, wear resistance and processability at the levels required for a member (e.g., a roller) to be used in an image-forming device (e.g., a printer). The thermoplastic elastomer composition contains a butyl rubber at a ratio of 30 to 80 mass % (inclusive), and further contains 15 to 50 parts by mass (inclusive) of an olefin thermoplastic resin and 10 to 100 parts by mass (inclusive) of a hydrogenerated styrene thermoplastic elastomer relative to 100 parts by mass of the rubber component, wherein the rubber component is finely dispersed by dynamic cross-linking.

### TECHNICAL FIELD

The present invention relates to a thermoplastic elastomer composition in which dynamically crosslinked rubber is dispersed and a vibration-proof and sound-proof member formed from the thermoplastic elastomer composition. The vibration-proof and sound-proof member is preferably used as a member, for printer equipment, demanded to remove vibration and noise generated when a paper feeding operation is performed.

### BACKGROUND ART

A rubber roller is used for a paper-feeding mechanism of an image-forming apparatus such as an ink-jet printer, a laser printer, an electrostatic copying machine, a facsimile apparatus, an automatic teller machine (ATM), and the like. Because it is necessary for the rubber roller to feed paper with the rubber roller picking up an object such as paper or a film to be fed by separating the object to be fed from objects to be fed disposed underneath, the rubber roller is demanded to have an excellent flexibility and a high wear resistance.

In recent years, as disclosed in U.S. Pat. No. 3,527,467 (patent document 1), a rubber roller of this kind composed of a thermoplastic elastomer superior to rubber in its processability and recyclability is proposed. The rubber rollers composed of the thermoplastic elastomer composition hitherto provided have improved flexibility and wear resistance.

But in recent years, with an increase in the printed number of sheets and the like per unit time in a printer or the like, the paper feeding speed is becoming higher and higher. The high-speed paper feeding imparts strong vibrations to the rubber roller, which causes a big noise to be generated. The noise is outstanding when the rubber roller rotating with the movement of paper contacts other members of the paper-feeding mechanism and stops suddenly after the rubber roller sends out the paper therefrom.

The generation of such a noise can be prevented by imparting vibration absorption performance to the rubber roller. It is known that butyl rubber is excellent in its vibration absorption performance. As disclosed in U.S. Pat. No. 3,443,958 (patent document 2), there is proposed a rubber composition or a thermoplastic elastomer composition which contains the butyl rubber as its main component and has an excellent vibration absorption performance.

But it is necessary for members such as a roller for use in the image-forming apparatus such as the printer to have a high accuracy. The above-described prior art thermoplastic elastomer composition has an insufficient processability. As described above, the rubber roller is demanded to have a high wear resistance. But in the patent document 2, description is not made on the wear resistance. Actually the wear resistance of the composition is insufficient.

Patent document 1: U.S. Pat. No. 3,527,467

Patent document 2: U.S. Pat. No. 3,443,958

### DISCLOSURE OF THE INVENTION

### Problem to be Solved by the Invention

The present invention has been made in view of the above-described problem. It is an object of the present invention to provide a thermoplastic elastomer composition which is excellent in its vibration-proof and sound-proof performance and has flexibility, wear resistance, and processability demanded for a member such as a roller to be used for an image-forming apparatus such as a printer.

### Means for Solving the Problem

To solve the above-described problem, the present invention provides a thermoplastic elastomer composition including:

a rubber component containing butyl rubber at not less than 30 mass % nor more than 80 mass %;

not less than 5 parts by mass nor more than 50 parts by mass of an olefin thermoplastic resin for 100 parts by mass of the rubber component; and

not less than 10 parts by mass nor more than 100 parts by mass of a hydrogenated styrene thermoplastic elastomer for 100 parts by mass of the rubber component,

wherein the rubber component is finely dispersed by dynamic crosslinking.

As the butyl rubber, known compounds may be used. Isobutylene-isoprene copolymer rubber, halogenated isobutylene-isoprene copolymer rubber, and denatured substances thereof are exemplified. As the denatured substance, a bromide of a copolymer of isobutylene and p-methylstyrene is exemplified.

The degree of unsaturation (amount of isoprene in the case of isobutylene-isoprene copolymer rubber) of the butyl rubber is normally 0.6 to 2.5 mol %.

As preferable halogen of the halogenated isobutylene-isoprene copolymer rubber, chlorine and bromine are exemplified. The content of the halogen is normally 1.1 to 2.4 mass %.

As the butyl rubber, one kind may be used singly or not less than two kinds may be used in combination. It is favorable for the rubber component to contain the isobutylene-isoprene copolymer rubber and more favorable to contain only the isobutylene-isoprene copolymer rubber.

The butyl rubber may be used in combination with other rubber components. As described above, the content ratio of the butyl rubber to the entire rubber component is set to 30 to 80 mass %. Thereby the thermoplastic elastomer composition is capable of maintaining a vibration-proof and sound-proof performance and securely obtaining a high processability and wear resistance.

The reason the above-described mixing ratio is set is because when the butyl rubber is contained in the rubber component at less than 30 mass %, the high vibration-proof and sound-proof performance of the butyl rubber cannot be displayed. On the other hand, when the butyl rubber is contained in the entire rubber component at more than 80 mass % of the entire rubber component, the high processability cannot be displayed. The above-described mixing ratio is set for the reason described below. Because the butyl rubber has a high Mooney viscosity, difficulties arise in dynamically crosslinking the rubber component. Further because the butyl rubber has a high adhesiveness, the obtained thermoplastic elastomer composition becomes adhesive. Thereby it is not easy to process the thermoplastic elastomer composition.

The “other rubber components” to be combined with the butyl rubber is not limited to specific ones. Nitrile rubber such as isoprene rubber, butadiene rubber, styrene-butadiene rubber, natural rubber, chloroprene rubber, acrylonitrile-butadiene rubber, hydrogenated nitrile rubber, norbornene rubber, ethylene propylene rubber, ethylene-propylene-diene rubber, acrylic rubber, ethylene acrylate rubber, fluorine rubber, chlorosulfonated polyethylene rubber, epichlorohydrin rubber, silicone rubber, urethane rubber, polysulfide rubber, phosphazene rubber, and 1,2-polybutadiene rubber are listed.

As the “other rubber components”, above all, rubbers compatible with the butyl rubber are preferable. The natural rubber, the isoprene rubber, the butadiene rubber, the styrene-butadiene rubber, the chloroprene rubber, the 1, 2-polybutadiene rubber, the acrylonitrile-butadiene rubber, and the ethylene-propylene-diene rubber are preferable.

As the “other rubber components”, one kind of the above-described other rubbers may be used singly or not less than two kinds thereof may be used in combination.

As the “other rubber components”, rubber components having a high processability are preferable. Ethylene-propylene-diene rubber (hereinafter referred to as EPDM rubber) can be especially suitably used because it has a favorable processability and is excellent in the compatibility with the butyl rubber.

The EPDM rubber includes an oil-unextended type consisting of a rubber component and an oil-extended type containing the rubber component and extended oil. Both types can be used in the present invention. As examples of diene monomers of the EPDM rubber, dicyclopentadiene, methylene norbornene, ethylidene norbornene, 1,4-hexadiene, and cyclooctadiene are listed.

As the olefin thermoplastic resin to be used in the present invention, polyethylene, polypropylene, ethylene ethyl acrylate resin, ethylene vinyl acetate resin, ethylene-methacrylate resin, ionomer resin, and chlorinated polyethylene are listed. Of these olefin thermoplastic resins, it is favorable to use the polypropylene or the polyethylene. It is more favorable to use the polypropylene. This is because the polypropylene is more flowable and more compatible with the butyl rubber than the polyethylene.

As described above, the content of the olefin thermoplastic resin is set to not less than 15 parts by mass nor more than 50 parts by mass for 100 parts by mass of the rubber component to maintain the vibration-proof and sound-proof performance and securely obtain a high processability. The reason the above-described mixing ratio is set is because when the content of the olefin thermoplastic resin is more than 50 parts by mass for 100 parts by mass of the rubber component, the high vibration-proof and sound-proof performance of the butyl rubber cannot be displayed. On the other hand, when the content of the olefin thermoplastic resin is less than 15 parts by mass for 100 parts by mass of the rubber component, a preferable flowability cannot be securely obtained and difficulties arise in dynamically crosslinking the rubber component or problems occur in the processability of the composition of the present invention.

The content of the olefin thermoplastic resin in the entire composition is set to favorably not more than 15 mass % and more favorably 10 to 15 mass %.

When the content of the olefin thermoplastic resin in the entire composition exceeds 15 mass %, the hardness of the composition increases. Thus it is difficult to apply the composition to members, for an image-forming apparatus, which are demanded to be flexible. On the other hand, when the content of the olefin thermoplastic resin is small, difficulties arise in dynamically crosslinking the rubber component and thus there is a case in which the processability of the composition becomes unfavorable. Therefore it is preferable that the content of the olefin thermoplastic resin in the entire composition is set to not less than 10 mass %.

As the hydrogenated styrene thermoplastic elastomer, it is possible to exemplify a hydrogenated conjugated diene polymer unit of a polymer block (A) containing a styrene monomer as its main component and a block (B) containing a conjugated diene compound as its main component. As the styrene monomer, it is possible to list styrene, α-methylstyrene, vinyl toluene, and t-butylstyrene. Only one kind of these monomers may be used or not less than two kinds thereof may be used in combination. The styrene is preferable as the styrene monomer. As the conjugated diene compound, it is possible to list butadiene, isoprene, chloroprene, and 2,3-dimethylbutadiene. Only one kind of these conjugated diene compounds may be used or not less than two kinds thereof may be used in combination.

As the hydrogenated styrene thermoplastic elastomers, a styrene-ethylene-styrene copolymer (SES), a styrene-ethylene/propylene-styrene copolymer (SEPS), a styrene-ethylene-ethylene/propylene-styrene copolymer (SEEPS), and a styrene-ethylene/butylene-styrene copolymer (SEBS) are listed.

It is especially favorable to use the styrene-ethylene-ethylene/propylene-styrene copolymer (SEEPS).

The reason the thermoplastic elastomer composition contains the hydrogenated styrene thermoplastic elastomer is because the hydrogenated styrene thermoplastic elastomer has a low hardness and a favorable affinity for a plasticizer such as oil. Because the thermoplastic elastomer composition contains the component having a low hardness, it is possible to adjust the hardness of a member such as a roller composed of the thermoplastic elastomer composition of the present invention to allow the member to have a preferable hardness. In a case where the thermoplastic elastomer composition is demanded to be flexible to a higher extent, the hardness thereof is often adjusted by adding the plasticizer such as oil to the thermoplastic elastomer composition. Because the hydrogenated styrene thermoplastic elastomer has a favorable affinity for the plasticizer such as the oil, when the plasticizer is added thereto, it is possible to process the thermoplastic elastomer composition easily and prevent the plasticizer from bleeding from a molding.

Because the double bonds of the hydrogenated styrene thermoplastic elastomer are saturated by hydrogenation, the hydrogenated styrene thermoplastic elastomer does not inhibit the dynamic crosslinking of the rubber component. This is one of the reasons the hydrogenated styrene thermoplastic elastomer is used.

As described above, the content ratio of the hydrogenated styrene thermoplastic elastomer is set to not less than 10 parts by mass nor more than 100 parts by mass for 100 parts by mass of the rubber component. Thereby the thermoplastic elastomer composition is capable of maintaining the vibration-proof and sound-proof performance and securely obtaining a high processability and wear resistance. The reason the above-described mixing ratio is set is because when the content ratio of the hydrogenated styrene thermoplastic elastomer is more than 100 parts by mass for 100 parts by mass of the rubber component, it is not possible to display the high vibration-proof and sound-proof performance of the butyl rubber nor maintain the high wear resistance demanded for the member such as the roller used for the image-forming apparatus such as the printer. On the other hand, when the content ratio of the hydrogenated styrene thermoplastic elastomer is less than 10 parts by mass for 100 parts by mass of the rubber component, the thermoplastic elastomer composition of the present invention shows a high hardness. Thus the thermoplastic elastomer composition is unpreferable in applying it to the member such as the roller used for the image-forming apparatus such as the printer.

A proper mixing ratio between the hydrogenated styrene thermoplastic elastomer and the olefin thermoplastic resin can be determined according to the kind of an elastomer to be used and that of a resin to be used. It is preferable to set the mixing amount of the hydrogenated styrene thermoplastic elastomer to not less than 30 parts by mass nor more than 300 for 100 parts by mass of the olefin thermoplastic resin. When the mixing amount of the hydrogenated styrene thermoplastic elastomer is less than 30 parts by mass, the hardness of the molding composed of the thermoplastic elastomer composition of the present invention is liable to become high. On the other hand, when the mixing amount of the hydrogenated styrene thermoplastic elastomer is more than 300 parts by mass, the ratio of the thermoplastic resin becomes relatively low. Thus it is impossible to obtain the effect to be obtained by mixing the thermoplastic resin with the thermoplastic elastomer. For example, the processability of the thermoplastic elastomer composition and the like cannot be improved.

In the thermoplastic elastomer composition of the present invention, the rubber component containing the butyl rubber is dynamically crosslinked and dispersed in the mixture of the olefin thermoplastic resin and the hydrogenated styrene thermoplastic elastomer. The rubber component is dynamically crosslinked, with a shearing force being applied to the thermoplastic elastomer composition. For example, the rubber component can be dynamically crosslinked by using a twin screw extruder.

By crosslinking the rubber component with the shearing force being applied to the thermoplastic elastomer composition, it is possible to set the diameters of rubber particles in the thermoplastic elastomer composition to several micrometers to several tens of micrometers and finely disperse the rubber component in the mixture of the olefin thermoplastic resin and the hydrogenated styrene thermoplastic elastomer.

A crosslinking agent for dynamically crosslinking the rubber component is not limited to a specific one, but known crosslinking agents can be used, provided that they are capable of crosslinking the rubber component contained in the thermoplastic elastomer composition. Sulfur, a resin crosslinking agent, metal oxides, and organic peroxides are exemplified. Of these crosslinking agents, the resin crosslinking agent is preferable because owing to its use, there little occurs the problem of blooming which often occurs in materials crosslinked with sulfur and a vulcanization accelerator.

The resin crosslinking agent is a synthetic resin which allows the rubber component to make a crosslinking reaction by heating. In the present invention, the resin crosslinking agent is not limited to a specific one, but known resin crosslinking agents can be used.

As the resin crosslinking agents, phenolic resin, melamine.formaldehyde resin, triazine.formaldehyde condensate, hexamethoxymethyl.melamine resin are listed. It is preferable to use the phenolic resin because when the thermoplastic elastomer composition containing the phenolic resin is used as a member constructing a paper supply mechanism, paper supply performance can be enhanced.

As examples of the phenolic resin, phenolic resins synthesized by reaction of phenols such as phenol, alkylphenol, cresol, xylenol or resorcinol with aldehydes such as formaldehyde, acetic aldehyde or furfural are listed. It is also possible to use halogenated phenolic resin in which at least one halogen atom is combined with the aldehyde unit of the phenolic resin.

It is preferable to use alkylphenol.formaldehyde resin obtained by reaction of formaldehyde with alkylphenol having an alkyl group connected to the ortho position or the para position of benzene, because the alkylphenol.formaldehyde resin is compatible with rubber and reactive, thus making a crosslinking reaction start time comparatively early. The alkyl group of the alkylphenol.formaldehyde resin has 1-10 carbon atoms. As the alkyl group, a methyl group, an ethyl group, a propyl group and a butyl group are exemplified. Halides of alkylphenol.formaldehyde resin can be preferably used.

It is also possible to use denatured alkylphenol resin formed by addition condensation of para-tertiary-butylphenol sulfide and aldehydes and alkylphenol.sulfide resin as the resin crosslinking agent.

The mixing amount of the resin crosslinking agent is favorably 1 to 50 parts by mass for 100 parts by mass of the rubber component. This is because when the mixing amount of the resin crosslinking agent is less than one part by mass, the rubber component is insufficiently crosslinked, which results in an inferior wear resistance. On the other hand, when the mixing amount of the resin crosslinking agent is more than 50 parts by mass, there is a case in which the hardness of the molding composed of the thermoplastic elastomer composition of the present invention becomes too high. The mixing amount of the resin crosslinking agent is more favorably 8 to 15 parts by mass.

To appropriately make a dynamic crosslinking reaction, a crosslinking activator may be used. As the crosslinking activator, metal oxides are used. Zinc oxide and zinc carbonate are preferable.

The mixing amount of the crosslinking activator is so set that the property of the rubber component is sufficiently displayed. For example, the mixing amount of the crosslinking activator is favorably 0.5 to 10 parts by mass and more favorably 1 to 10 parts by mass for 100 parts by mass of the rubber component.

The organic peroxides are not limited to specific ones, but it is possible to use any compounds capable of crosslinking the rubber component. For example, benzoyl peroxide, 1,1-bis(tert-butylperoxy)-3,3,5-trimethylcyclohexane, 2,5-dimethyl-2,5-di(benzoylperoxy)hexane, di(tert-butylperoxy)diisopropylbenzene, 1,4-bis[(tert-butyl)peroxyisopropyl]benzene, di(tert-butylperoxy)benzoate, tert-butyl peroxybenzoate, dicumyl peroxide, tert-butyl cumyl peroxide, 2,5-dimethyl-2,5-di(tert-butylperoxy)hexane, di-tert-butyl peroxide, and 2,5-dimethyl-2,5-di(tert-butylperoxy)-3-hexene. These compounds may be used singly or in combination of two or more kinds thereof.

It is preferable that the mixing amount of the organic peroxide is 0.2 to 3.0 parts by mass for 100 parts by mass of the rubber component. When the mixing amount of the organic peroxide is less than 0.2 parts by mass, the rubber component is insufficiently crosslinked and thus the wear resistance and the like of the thermoplastic elastomer composition are inferior. On the other hand, when the mixing amount of the organic peroxide is more than 3.0 parts by mass, the property of the thermoplastic elastomer composition deteriorates owing to molecule cut and in addition defective dispersion occurs. Thereby it is difficult to process the thermoplastic elastomer composition.

The lower limit of the mixing amount of the organic peroxide is more favorably 0.5 parts by mass and especially favorably 1.0 part by mass for 100 parts by mass of the rubber component. The upper limit of the mixing amount of the organic peroxide is more favorably 2.5 parts by mass and especially favorably 2.0 parts by mass for 100 parts by mass of the rubber component.

A co-crosslinking agent may be used together with the organic peroxide. The co-crosslinking agent crosslinks itself and reacts with molecules of rubber and crosslinks them, thus making the entire rubber component polymeric. By co-crosslinking the rubber component with the co-crosslinking agent, it is possible to increase the molecular weight of crosslinked molecules and improve the wear resistance and the like of the thermoplastic elastomer composition.

As the co-crosslinking agent, polyfunctional monomers, metal salts of methacrylic acid or acrylic acid, methacrylate ester, aromatic vinyl compounds, heterocyclic vinyl compounds, allyl compounds, polyfunctional polymers to be obtained by utilizing the functional group of 1,2-polybutadiene, and dioximes are listed.

In using the co-crosslinking agent and the organic peroxide together, the mixing amount of the co-crosslinking agent can be selected appropriately according to the kind thereof and the kind of other components to be used. The mixing amount of the co-crosslinking agent is set to favorably not less than 5 nor more than 20 parts by mass and more favorably not less than 10 nor more than 15 parts by mass for 100 parts by mass of the rubber component.

The thermoplastic elastomer composition of the present invention may contain other components unless the use thereof is contrary to the object of the present invention.

As other components, a softener can be used as necessary to provide the thermoplastic elastomer composition with a moderate degree of flexibility and elasticity.

As the softener, oil and a plasticizer can be used. As the oil, it is possible to use mineral oil such as paraffin oil, naphthenic oil, aromatic oil and known synthetic oil composed of a hydrocarbon oligomer, and process oil. As the synthetic oil, it is possible to use an oligomer of α-olefin, an oligomer of butene, and an amorphous oligomer of ethylene and α-olefin. As the plasticizer, phthalate-based, adipate-based, sebacate-based, phosphate-based, polyether-based, and polyester-based plasticizers are listed. More specifically dioctyl phthalate (DOP), dibutyl phthalate (DBP), dioctyl sebacate (DOS), and dioctyl adipate (DOA) are listed.

The mixing amount of the softener is set to favorably not more than 600 parts by mass and more favorably not more than 400 parts by mass for 100 parts by mass of the rubber component. When the mixing amount of the softener is more than the above-described range, the softener may bleed from the surface of the thermoplastic elastomer composition or may inhibit crosslinking and thus the rubber component is insufficiently crosslinked. Thereby the property of the thermoplastic elastomer composition may deteriorate. The lower limit of the mixing amount of the softener is not limited to a specific mixing amount, but should be so set as to obtain the effect to be obtained by the addition of the softener to the rubber component, namely, the effect of improving the dispersibility of the rubber component at a dynamic crosslinking time. Normally the mixing amount of the softener is set to not less than 15 parts by mass.

As the method of using the softener for the composition, a method of adding the softener to the composition before performing a dynamic crosslinking and thereafter kneading all the components and a method of adding the softener to a part of the components of the composition and kneading the softener and a part of the components and thereafter kneading all the components are exemplified.

As the latter method, a method of adding the oil-extended EPDM rubber to the composition and a method of using the oil-extended hydrogenated styrene thermoplastic elastomer are exemplified.

When oil-extended epichlorohydrin rubber or the oil-extended hydrogenated styrene thermoplastic elastomer is used, the extended oil plays a role as the softener. Therefore the amount of the extended oil is regarded as the mixing amount of the softener.

To improve the mechanical strength of the thermoplastic elastomer composition, a filler can be added thereto.

As the filler, it is possible to list powder such as silica, carbon black, clay, talc, calcium carbonate, titanium oxide, dibasic phosphite (DLP), basic magnesium carbonate, and alumina.

It is preferable that the mixing amount of the filler is not more than 30 parts by mass for 100 parts by mass of the rubber component. When the ratio of the filler exceeds the above-described range, the flexibility of the thermoplastic elastomer composition deteriorates.

An acid-accepting agent can be used for the thermoplastic elastomer composition. When rubber such as the halogenated isobutylene-isoprene copolymer rubber containing halogen is used as the rubber component, by using the acid-accepting agent for the thermoplastic elastomer composition, it is possible to prevent a halogen gas generated at a dynamic crosslinking time from remaining.

As the acid-accepting agent, it is possible to use various substances acting as an acid acceptor. As the acid-accepting agent, carbonates of magnesium or calcium are exemplified as preferable examples. It is also possible to use hydrotalcites and magnesium oxide.

The mixing amount of the acid-accepting agent for 100 parts by mass of the rubber component is set to favorably not less than 0.1 nor more than 10 parts by mass and more favorably not less than 0.5 nor more than 5 parts by mass.

In addition, the thermoplastic elastomer composition may appropriately contain additives such as a lubricant, an age resistor, an antioxidant, an ultraviolet ray absorber, a pigment, an antistatic agent, a fire retarding agent, a neutralizing agent, a nucleating agent, an anti-foam agent, and the like.

As the lubricant, higher fatty amide, unsaturated fatty amide, and the like are exemplified.

As the age resistor, imidazoles such as 2-mercaptobenzimidazole; amines such as phenyl-α-naphthylamine, N,N′-di-6-naphthyl-p-phenylenediamine, and N-phenyl-N′-isopropyl-p-phenylenediamine; and phenols such as 2-6-di-tert-butyl-4-methylphenol, 2,2′-methylenebis(4-methyl-6-tert-butylphenol), and 2,5-di-tert-butylhydroquinone are listed.

The thermoplastic elastomer composition of the present invention can be produced by a method described below.

Initially the rubber component containing at least the butyl rubber, the olefin thermoplastic resin, the hydrogenated styrene thermoplastic elastomer, the crosslinking agent, and other desired additives are supplied to a kneader such as a Henschel mixer, a super-mixer or the like and kneaded or mixed with one another with a tumbler. All the components may be kneaded or mixed with one another all together or after a part of all the components may be kneaded or mixed with one another in advance, remaining components may be added to the components kneaded or mixed in advance and thereafter all the components may be kneaded or mixed with one another.

After the kneaded components or the mixed components are supplied to a uniaxial extruder or a twin screw extruder, with the kneaded components or the mixed components being heated to 150 to 250° C. and with a shearing force being applied thereto, the rubber component is dynamically crosslinked with the crosslinking agent. Thereafter the rubber component is dispersed in the mixture of the olefin thermoplastic resin and the hydrogenated styrene thermoplastic elastomer.

The dynamic crosslinking may be performed in the presence of halogen such as chlorine, bromine, fluorine or iodine. To allow the halogen to be present at a dynamic crosslinking time, it is favorable to use a halogenated rubber component described above or a halogen-donating substance. As the halogen-donating substance, tin chloride such as stannic chloride, ferric oxide, and cupric chloride are listed. In addition, halogenated resin such as chlorinated polyethylene may be used. One of the halogen-donating substances may be used singly or in combination of not less than two kinds thereof.

It is preferable to pelletize the thermoplastic elastomer composition obtained by carrying out the above-described method to facilitate processing to be performed at subsequent steps. Thereby it is possible to obtain a preferable moldability.

It is possible to use the thermoplastic elastomer composition of the present invention for various applications. Above all, the thermoplastic elastomer composition is used as vibration-proof and sound-proof members by utilizing the characteristics thereof and suitably used as members, for printer equipment, demanded to remove vibration and noise generated when a paper feeding operation is performed.

More specifically it is preferable to use the thermoplastic elastomer composition of the present invention as members contributing to the feeding of paper (thin material like paper) in an image-forming apparatus such as a printer including an inject printer or a laser printer, an electrostatic copying machine, a facsimile apparatus, an automatic teller machine (ATM), and the like. More specifically the thermoplastic elastomer composition of the present invention is applicable to a separation sheet or a separation pad for preventing double feed of paper and to a paper feed roller. It is especially preferable to apply the thermoplastic elastomer composition of the present invention to a paper supply roller and a transport roller constructing a paper supply mechanism or to the paper feed roller such as a paper discharge roller.

### EFFECT OF THE INVENTION

In the present invention, as the rubber component, the butyl rubber and other rubber components are combined with each other. The content ratio of the butyl rubber is set to 30 to 80 mass % for the entire rubber component. Further the mixture of the olefin thermoplastic resin and the hydrogenated styrene thermoplastic elastomer serving as the matrix in which the dynamically crosslinked rubber component is dispersed is used at a specific mixing ratio. Thereby the present invention is capable of providing the thermoplastic elastomer composition having a necessary flexibility and wear resistance.

### BRIEF DESCRIPTION OF THE DRAWINGS

FIG. 1 is a diagram of a rubber roller which is one form of a vibration-proof and sound-proof member formed by using a thermoplastic elastomer composition of the present invention.

### EXPLANATION OF REFERENCE SYMBOLS AND NUMERALS

10: rubber roller
11: rubber layer
12: core

### BEST MODE FOR CARRYING OUT THE INVENTION

The embodiment of the elastomer composition of the present invention composing a rubber roller is described below.

The thermoplastic elastomer composition contains the rubber component containing the butyl rubber at not less than 30 mass % nor more than 80 mass %, not less than 5 parts by mass nor more than 50 parts by mass of the olefin thermoplastic resin for 100 parts by mass of the rubber component, and not less than 10 parts by mass nor more than 100 parts by mass of the hydrogenated styrene thermoplastic elastomer for 100 parts by mass of the rubber component. The rubber component is finely dispersed in a matrix component consisting of a mixture of the olefin thermoplastic resin and the hydrogenated styrene thermoplastic elastomer by dynamic crosslinking.

The rubber component contains the butyl rubber and the EPDM rubber. As the butyl rubber, it is preferable to use isobutylene-isoprene copolymer rubber. Regarding the ratio of the butyl rubber and the EPDM rubber to the rubber component, the ratio of the butyl rubber to the entire rubber component is set to 30 to 80 mass % and preferably 50 to 70 mass %. The ratio of the EPDM rubber to the entire rubber component is set to 20 to 70 mass % and preferably 30 to 50 mass %.

It is preferable to use polypropylene as the olefin thermoplastic resin. The mixing amount of the olefin thermoplastic resin is favorably 15 to 50 parts by mass and more favorably 20 to 40 parts by mass for 100 parts by mass of the rubber component. It is preferable to set the content of the olefin thermoplastic resin to 10 to 15 mass % in the entire composition.

As the hydrogenated styrene thermoplastic elastomer, it is preferable to use a styrene-ethylene-ethylene/propylene-styrene copolymer. The mixing amount of the hydrogenated styrene thermoplastic elastomer is favorably 10 to 100 parts by mass, more favorably 10 to 80 parts by mass, and especially favorably 15 to 60 parts by mass for 100 parts by mass of the rubber component.

Regarding the mixing ratio between the olefin thermoplastic resin and the hydrogenated styrene thermoplastic elastomer, it is preferable to use 50 to 200 parts by mass of the hydrogenated styrene thermoplastic elastomer for 100 parts by mass of the olefin thermoplastic resin.

As a crosslinking agent for crosslinking the rubber component, a resin crosslinking agent is preferable. It is especially preferable to use a phenolic resin crosslinking agent. The mixing amount of the phenolic resin crosslinking agent is 1 to 20 parts by mass and preferably 8 to 15 parts by mass for 100 parts by mass of the rubber component.

To properly make a crosslinking reaction, the crosslinking activator of the present invention includes the zinc oxide. It is preferable to use 1 to 10 parts by mass of the zinc oxide for 100 parts by mass of the rubber component.

The softener of the present invention includes paraffinic process oil. The mixing amount of the paraffinic process oil is 15 to 250 parts by mass, favorably 15 to 150 parts by mass, and more favorably 20 to 100 parts by mass for 100 parts by mass of the rubber component.

Although the thermoplastic elastomer composition of the present invention is produced by a method described below, the method of producing it is not limited to the method described below.

The above-described components are supplied to a tumbler at a required mixing ratio and mixed with one another. A mixing period of time is set to 15 minutes. A pellet of the thermoplastic elastomer composition is obtained by supplying the obtained mixture to a twin screw extruder, dynamically crosslinking it at 150 to 250° C., preferably 180 to 200° C., and dispersing the rubber component uniformly.

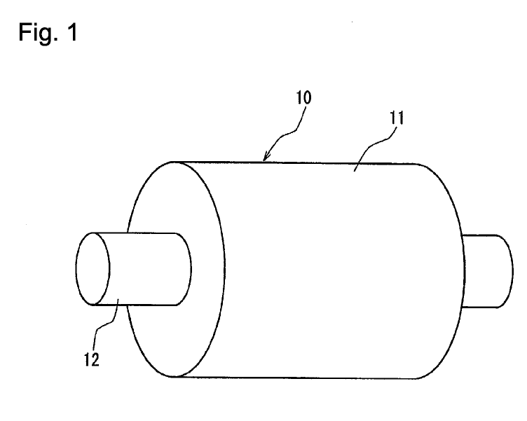

By tubularly extruding the pellet by the extruder and cutting the extruded pellet, a vibration-proof and sound-proof member consisting of a rubber roller for printer equipment shown in FIG. 1 is formed.

Specifically, after the pellet is tubularly extruded by using the single screw extruder in a condition of 190 to 220° C. and cut to a required length, a core is inserted into a hollow portion of the rubber roller by press fit or both are bonded to each other with an adhesive agent. In this manner, both are fixed to each other.

It is possible to obtain a rubber roller by injecting the pellet with an injection molding machine to tubularly shape the pellet and cutting the molding to a required length after the surface thereof is polished.

By inserting an approximately D-shaped core material into the hollow portion of a cylindrical rubber layer by press fit, it is possible to obtain an approximately D-shaped rubber roller.

A laurette-shaped groove may be formed on the surface of the rubber roller.

As described above, a rubber roller 10 has a columnar core 12 and a rubber layer 11 on the surface of the core 12.

The rubber layer 11 may have any constructions, provided that the rubber layer 11 has a layer consisting of the thermoplastic elastomer composition. But the rubber roller having only the layer consisting of the thermoplastic elastomer composition of the present invention is simple in its construction and thus preferable in consideration of the production process management and the cost.

As the material of the core 12, metal such as aluminum, an aluminum alloy, SUS, and iron; and ceramics are listed.

The thickness of the rubber roller is set to favorably 1 to 20 mm and more favorably 2 to 20 mm. When the thickness of the rubber roller is less than 1 mm, the rubber roller lacks a necessary degree of elasticity. For example, when the rubber roller is used for a paper-feeding mechanism, the rubber roller is liable to deteriorate in its paper-feeding performance. When the thickness of the rubber roller is more than 20 mm, the rubber roller is so large that it is difficult to mount the rubber roller on a copying machine, a printer, and the like.

It is favorable that the hardness of the rubber roller measured in accordance with JIS K 6253 is not less than 20 nor more than 60. The rubber roller having the hardness in this range shows a good flexibility and is thus capable of sufficiently displaying desired functions. The hardness of the rubber roller of the present invention is more favorably not less than 30 nor more than 50 and especially favorably not less than 40 nor more than 50.

The tan δ (loss tangent) of the rubber roller measured at a temperature of 24° C. in accordance with JIS K 6394 is favorably not less than 0.12 and more favorably 0.12 to 0.16. When the tan δ (loss tangent) is less than 0.12, the vibration-proof and sound-proof performance of the rubber roller is insufficient and thus vibration and noise become conspicuous when the rubber roller is applied to products, which gives an unfavorable impression to a high extent.

Examples of the present invention and comparison examples are described in detail below.

Dynamically crosslinked thermoplastic elastomer composition of each of the examples and the comparison examples was formed by using the components shown in table 1. A cylindrical rubber roller of each of the examples and the comparison examples was formed by using the obtained thermoplastic elastomer composition.

TABLE 1

| | | | | | Comparison | Comparison | Comparison | Comparison | Comparison | Comparison |
|---|---|---|---|---|---|---|---|---|---|---|
| | | Example 1 | Example 2 | Example 3 | example 1 | example 2 | example 3 | example 4 | example 5 | example 6 |
| Rubber | Butyl rubber | 70 | 70 | 50 | 20 | 90 | 70 | 70 | 70 | 70 |
| component | other | 30 | 30 | 50 | 80 | 10 | 30 | 30 | 30 | 30 |
| | rubber | | | | | | | | | |
| | components | | | | | | | | | |
| | Total | 100 | 100 | 100 | 100 | 100 | 100 | 100 | 100 | 100 |

| | | | | | | | | | |
|---|---|---|---|---|---|---|---|---|---|
| Thermoplastic resin | 30 | 30 | 30 | 30 | 30 | 10 | 60 | 30 | 30 |
| Thermoplastic elastomer | 15 | 60 | 15 | 15 | 15 | 15 | 15 | 5 | 120 |
| Resin crosslinking agent | 12 | 12 | 12 | 12 | 12 | 12 | 12 | 12 | 12 |
| Softener | 50 | 50 | 50 | 50 | 50 | 50 | 50 | 50 | 50 |
| Zinc oxide | 5 | 5 | 5 | 5 | 5 | 5 | 5 | 5 | 5 |
| Processability | ◯ | ◯ | ◯ | ◯ | ◯ | X | ◯ | ◯ | ◯ |
| Hardness | 50 | 40 | 48 | 47 | 53 | — | 72 | 57 | 33 |
| Tanδ | 0.16 | 0.14 | 0.12 | 0.09 | 0.16 | — | 0.13 | 0.16 | 0.09 |
| Processability test | ◯ | ◯ | ◯ | ◯ | X | — | ◯ | Δ | Δ |
| Wear resistance test | ◯ | Δ | ◯ | ◯ | Δ | — | ◯ | Δ | X |

Materials used are as shown below.

Butyl rubber: isobutylene-isoprene copolymer rubber (“butyl 268” (commercial name) produced by Exxon Mobil Corporation)

Other rubber components: EPDM rubber (“Esprene 670F” (commercial name) produced by Sumitomo Chemical Co., Ltd.) (The EPDM rubber is oil-extended rubber and contains 50 mass % of process oil. Therefore 50 mass % of the mass of the added EPDM rubber is described in the column of “other rubber components” in table 1, whereas the remaining 50 mass % was treated as “softener”. That is, in the column of the “softener” in table 1, the sum of the amount of the paraffinic process oil shown below and the amount of the extended oil of the EPDM rubber is shown.)

Olefin thermoplastic resin (shown as merely “thermoplastic resin” in table 1): polypropylene resin (“BC6” (commercial name) produced by Nippon Polychemicals Co., Ltd.)

Hydrogenated styrene thermoplastic elastomer (shown as merely “thermoplastic elastomer” in table 1): a styrene-ethylene-ethylene/propylene-styrene copolymer (“SEPTON 4077” (commercial name) produced by Kuraray Co., Ltd.)

Resin crosslinking agent: halogenated alkylphenol resin crosslinking agent (“Tackirol 250-III (commercial name) produced by Taoka Chemical Co., Ltd.

Softener: paraffinic process oil (“Diana process oil PW-380” (commercial name) produced by Idemitsu Kosan Co., Ltd.

Zinc oxide: two kinds of zinc oxide (produced by Nippon Coke & Engineering Co., Ltd.)

The producing method is as described below.

After the components shown in table 1 were used at the ratio shown in table 1 and mixed with one another by using a tumbler, the components were kneaded with a twin screw extruder (“HTM38” produced by Aibeck Co., Ltd.) at a speed of 200 rpm, with the components being heated to 180 to 200° C., and the rubber component was to dynamically crosslinked. In this manner, the thermoplastic elastomer composition of each of the examples and the comparison examples was prepared and was pelletized.

Each of the obtained pellets was extruded at 190 to 220° C. and at a speed of 20 rpm by using a Φ50 single screw extruder (produced by Kasamatsu Plastic Engineering & Research Co., Ltd.). After each molding was cut, a core was inserted into the molding to produce the cylindrical rubber roller of each of the examples and the comparison examples.

Various evaluations were made on the cylindrical rubber rollers of the examples and the comparison examples by carrying out methods described below. Results of the evaluations are shown in table 1.

Processability in Dynamic Crosslinking

The configurations of the pellets were evaluated at two stages when the dynamic crosslinking was performed.

◯: Good. The rubber component of the pellet was dynamically crosslinked, and a uniform pellet was obtained.
X: Unacceptable. The thermoplastic elastomer composition was unfavorable in its flowability, and a powdery composition was obtained.

Hardness

In accordance with JIS K 6253, a type A durometer hardness test was conducted in a constant temperature and humidity condition where an ambient temperature was 23° C. and a relative humidity was 55%.

Tan δ

In accordance with JIS K 6394, tan δ (loss tangent) was measured at 24° C.

Processability Test

In extruding each thermoplastic elastomer composition to form it into the cylindrical rubber roller, the degree of smoothness of the surface of each molding and the amount of resin generated at the mouthpiece of the extruder were evaluated visually at the following three stages.

◯: Excellent. The surface of the molding was smooth, and no resin was generated at the mouthpiece of the extruder.
Δ: Acceptable. Some unsmooth portions were observed on the surface of the molding or resin was generated to a very low extent at the mouthpiece of the extruder.
X: Unacceptable. Unsmooth portions were observed on the surface of the molding to a high extent or a large amount of resin was generated at the mouthpiece of the extruder.

Wear Resistance Test

The cylindrical rubber roller, having a diameter of 30 mm and a width of 10 mm, which was obtained by molding each thermoplastic elastomer composition was forcibly rotated at a speed of 100 rpm for two minutes by applying a load of 2.0N thereto with the cylindrical rubber roller in contact with paper (SK paper produced by Canon Inc.). A change in the mass of the cylindrical rubber roller before and after the test was conducted was measured to evaluate the wear resistance of each rubber roller at three stages according to a decreased mass %.

◯: Good. A change in the mass of the rubber roller before and after the test was conducted was not more than 0.05%.
Δ: Acceptable. A change in the mass of the rubber roller before and after the test was conducted exceeded 0.05% and not more than 0.1%.
X: Unacceptable. A change in the mass of the rubber roller before and after the test was conducted exceeded 0.1%.

From the test results of the examples and the comparison examples, it was found that in the thermoplastic elastomer composition of comparison example 1 containing a small amount of the butyl rubber had a small tan δ which is an indicator of the vibration-proof and sound-proof performance. Thus the thermoplastic elastomer composition of comparison example 1 was unpreferable. The thermoplastic elastomer composition of comparison example 2 containing a large amount of the butyl rubber had a large tan δ, but had a low processability and an insufficient wear resistance and was thus unpreferable.

It was difficult to dynamically crosslink the rubber component of the thermoplastic elastomer composition of comparison example 3 containing a small amount of the olefin thermoplastic resin, and a molding was not obtained. The thermoplastic elastomer composition of comparison example 4 containing a large amount of the olefin thermoplastic resin had a high hardness and was thus unpreferable.

The thermoplastic elastomer composition of comparison example 5 containing a small amount of the hydrogenated styrene thermoplastic elastomer had insufficient processability and wear resistance. The thermoplastic elastomer composition of comparison example 6 containing a large amount of the hydrogenated styrene thermoplastic elastomer was inferior in its wear resistance and was thus unpreferable.

On the other hand, the thermoplastic elastomer compositions of examples 1 through 3 were excellent in the flowability thereof when the rubber component was dynamically crosslinked, could be easily molded, and in addition were excellent in the processability thereof. Further each of the cylindrical rubber rollers obtained from the compositions had a proper degree of hardness, had a large tan δ, and was excellent in the vibration-proof and sound-proof performance and wear resistance thereof.

1-5. (canceled)

6. A vibration-proof and sound-proof member for printer equipment formed by using a thermoplastic elastomer composition, comprising:
a rubber component consisting of butyl rubber and ethylene-propylene-diene rubber and containing butyl rubber at not less than 30 mass % nor more than 80 mass %;
not less than 15 parts by mass nor more than 50 parts by mass of an olefin thermoplastic resin for 100 parts by mass of said rubber component;
not less than 10 parts by mass nor more than 100 parts by mass of a hydrogenated styrene thermoplastic elastomer for 100 parts by mass of said rubber component; and
not less than one part by mass nor more than 50 parts by mass of a resin crosslinking agent for 100 parts by mass of said rubber component,
said rubber component being finely dispersed by dynamic crosslinking,
said vibration-proof and sound-proof member for printer equipment having a tan δ (loss tangent) not less than 0.12 when said tans is measured at a temperature of 24° C. in accordance with JIS K 6394.

7. The vibration-proof and sound-proof member for printer equipment according to claim 6, wherein said thermoplastic elastomer composition further contains 0.5 to 10 parts by mass of zinc oxide or zinc carbonate for 100 parts by mass of said rubber component and 15 to 600 parts by mass of a softener for 100 parts by mass of said rubber component.
